(19) United States
(12) Patent Application Publication
(10) Pub. No.: US 2011/0276570 A1
(43) Pub. Date: Nov. 10, 2011

(54) Methods, Apparatuses, and Computer Program Products for Adding Profile Data

(75) Inventors: Staffan Larsson, Uppsala (SE); Torgny Johansson, Kalix (SE); Marika Stålnacke, Lulea (SE)

(73) Assignee: TELEFONAKTIEBOLAGET LM ERICSSON (PUBL), Stockholm (SE)

(21) Appl. No.: 13/146,417

(22) PCT Filed: Jan. 29, 2009
(86) PCT No.: PCT/SE2009/050090

§ 371 Date: Jul. 27, 2011

(51) Int. Cl. G06F 17/30

(52) U.S. Cl. 707/736; 707/E17.014

(57) ABSTRACT

It is presented a method being performed in a server (5). The method comprises the steps of: receiving, from a mobile terminal (1), identity data for a first user and tag data of a tag (3). The tag data has been detected using local communication (2) of the mobile terminal, and the tag data is coupled to a profile data item for a user profile for the first user. Furthermore, the method includes obtaining time data related to when the tag data was detected; adding the profile data item and the time data to the user profile; and finding a user profile of a second user in a database (6) containing user profiles, wherein the user profile of the second user matches, using at least one criteria, the user profile of the first user. A corresponding mobile terminal method is also presented, along with associated apparatuses and server program products.

### TECHNICAL FIELD

The invention relates generally to social networking systems, and more particularly to facilitating user profile updates in such systems.

### BACKGROUND

Social networking is a regular activity both in private and professional life. In private life, social networking often centres around previous real life connections or common interests such as sports, pets or music. Professionally, the network of business contacts is a very valuable asset, used to act on sales leads, identify business partnerships, job opportunities, venture financing, recruitment etc.

One important aspect of networking is to form relations with new people, which in turn involves two activities: identifying potential people to connect with, and then initiating the contact.

Events and social gatherings are common opportunities to meet new contacts, based on shared interests. Events normally focus on a more or less widely defined subject, like an electronics trade fair, a scientific conference, an art exhibition or a music festival. At large events, however, it is still a challenge to identify the right potential contacts and to approach them in a good way.

The U.S. Pat. No. 7,310,676 presents a business or social networking method operative in a server. The method enables mobile device users to meet one another, on a permission basis. The determination of whether a given pair of mobile device users are introduced depends on whether the server determines they are in intellectual or “cognitive” proximity, which is typically a function of one or more factors, such as: each user's reciprocal networking objective, the nature of the industry in which the user works, the user's level within the management hierarchy of his or her company, any specialty function the individual may possess, and so on. When given mobile devices users are within physical proximity of one another during an overlapping time window, the server determines whether the users are also within a given intellectual proximity. If so, and if the mobile device users agree to be introduced, the server establishes a direct private messaging session between them. However, this solution is heavily dependent on information from profiles being created and updated manually by the users. This can be very time consuming and as a consequence, much profile data is outdated and/or not very detailed. Hence, contact matching in current services is not precise enough. They are based on data that is too old, miss important aspects or are irrelevant in the specific situation.

### SUMMARY

An object of the invention is to simplify profile management for user profiles in a networking system.

According to a first aspect of the invention, it is presented a method being performed in a server. The method comprises the steps of: receiving, from a mobile terminal, identity data for a first user; receiving, from the mobile terminal, tag data of a tag, wherein the tag data has been detected using local communication of the mobile terminal, and the tag data is coupled to a profile data item for a user profile for the first user; obtaining time data related to when the tag data was detected; adding the profile data item and the time data to the user profile, the user profile being identified using the identity data; and finding a user profile of a second user in a database containing user profiles, wherein the user profile of the second user matches, using at least one criteria, the user profile of the first user.

By updating the user profile using tag data of the tag, profile management is greatly simplified. This allows the user to simply locally communicate with (e.g. in the example of near field communication, touch, using a mobile terminal) appropriate tags to update the user profile, providing an intuitive and attractive way to perform the profile management, particularly in locations where the user ordinarily does not have access to, or where it would be cumbersome and/or expensive to provide, a computer with a full-size display and full-size keyboard. Moreover, the solution can be used in competitions, for example by actively promoting the participants to go to a number of booths, etc.

The method may further comprise a step, prior to the step of adding, of: creating, when a previous user profile for the first user is missing, a user profile for the first user. Consequently, the user does not even have to have a user profile previously registered to start using the networking system; the user profile will simply be created automatically the first time the user performs local communication with a desired tag.

In the step of finding a matching second user, a condition for finding a match may be that privacy policies of both the first and second user are complied with. In other words, any user can in this way create privacy policies to reduce the risk for undesired matches.

The method may further comprise the step of: receiving additional data, the additional data corresponding to user input received from the first user, the additional data being coupled to the tag data. Using additional data, the user can be prompted for any suitable complementary information, be it a multiple choice question with one or more allowable concurrent choices, text data or a number.

The method may further comprise the step of: determining a tag position using the tag data. Furthermore, the step of adding may comprise adding the tag position to the user profile. In other words, the user profile may be updated with position data. This allows other users to see where the user in question was last known to have been, e.g. a certain room.

The profile data item may represent a professional interest of the first user selected from at least one of: a professional role, an employer, an age, a country of residence, employer size, subject area of interest, seniority, and intended purchase volume.

The method may comprise removing user profile data from storage after an event, to which the user data is associated, has ended. In other words, the user data is coupled to a specific event and the user data is removed when the event ends. By removing all profile data after the event, the required storage capacity is greatly reduced. Since user profile creation is so easy, the user would simply create a new profile for each event. Furthermore, it can be attractive from a privacy perspective to only keep the profile data during a defined time interval.

The method may further comprise the step of: notifying at least one of the first user and the second user, of a match between the first user and the second user. This provides an intuitive and direct way for the users of any match to communicate.

A second aspect of the invention is a method performed in a mobile terminal. The method comprises the steps of: obtaining identity data for a user; detecting, using local communication of the mobile terminal, tag data of a tag; sending the tag data to an apparatus for adding a profile data item coupled to the tag data to a user profile for the first user.

The method may further comprise the step of receiving user input for additional data coupled to the tag data.

In the step of detecting, the local communication may be selected from at least one of: near field communication, one dimensional barcode reading, two dimensional barcode reading, and Bluetooth/IEEE 802.15.

The step of sending may comprise sending the data using a data transfer technology selected from at least one of: a local area network, wide area network, a Bluetooth network.

The step of obtaining identity data may comprise obtaining an identifier of a subscriber coupled to the mobile terminal. Using a subscriber entity is an unambiguous identifier. Furthermore, this identifier can be used to obtain data from external systems, as subscriber identifiers such as phone numbers are often present in external systems. The matching with such external systems may require pre-processing of both identifiers, removing any superfluous characters, e.g. white spaces or hyphens, and removing, adding or ignoring country code data.

The method may comprise the step of obtaining position data of the mobile terminal, and wherein the step of sending further comprises sending the position data to the server.

A third aspect of the invention is a server comprising a controller. The controller is configured to receive, from a mobile terminal, identity data for a first user; the controller is configured to receive, from the mobile terminal, tag data of a tag, wherein the tag data has been detected using local communication of the mobile terminal, and the tag data is coupled to a profile data item for a user profile for the first user; the controller is configured to obtain time data related to when the tag data was detected; the controller is configured to add the profile data item and the time data to the user profile, the user profile being identified using the identity data; and the controller is configured to find, a user profile of a second user in a database containing user profiles, wherein the user profile of the second user matches, using at least one criteria, the user profile of the first user.

A fourth aspect of the invention is a mobile terminal comprising: a detector for detecting, using local communication of the mobile terminal, tag data of a tag; a controller; a transmitter; and a receiver. The controller is configured to obtain identity data for a first user; the controller is configured to obtain time data for when the tag data was detected; the transmitter is configured to send the tag data to an apparatus for adding a profile data item coupled to the tag data to a user profile for the first user; and the receiver is adapted to receive a notification indicating a match between the first user and a second user, the second user matching, using at least one criteria, the user profile of the first user.

The detector may be configured to use at least one of the following detecting technologies: near field communication, one dimensional barcode, two dimensional barcode, and Bluetooth.

A fifth aspect of the invention is a computer program product comprising software instructions that, when executed in a server, causes the server to perform a method comprising the steps of: receiving, from a mobile terminal, identity data for a first user; receiving, from the mobile terminal, tag data of a tag, wherein the tag data has been detected using local communication of the mobile terminal, and the tag data is coupled to a profile data item for a user profile for the first user; obtaining time data related to when the tag data was detected; adding the profile data item and the time data to the user profile, the user profile being identified using the identity data; and finding a user profile of a second user in a database containing user profiles, wherein the user profile of the second user matches, using at least one criteria, the user profile of the first user.

A sixth aspect of the invention is a computer program product comprising software instructions that, when executed in a controller of a mobile terminal, causes the mobile terminal to perform the steps of: obtaining identity data for the first user; detecting, using local communication of the mobile terminal, tag data of a tag; sending the tag data to an apparatus for adding a profile data item coupled to the tag data to a user profile for the first user.

Whenever the phrase local communication is used herein, it is to be construed as a direct wireless communication between two objects. This can for instance be implemented using radio transmission, optical reading, inductive coupling, etc. For example, when local communication is used to detect, using a mobile terminal, tag data associated with a tag, the tag data is detected without any intermediate links between the mobile terminal and the tag data. For example, local communication can be performed using near field communication, one dimensional barcode reading, two dimensional barcode reading, Bluetooth, or any combination of the above.

Whenever the term tag is used herein, it is to be construed as a physical object with tag data that can be read by a machine, such as a mobile terminal.

It is to be noted that any feature of the first, third and fifth aspects may, where appropriate, be applied to any other of these aspects. Furthermore any feature of the second, fourth and sixth aspects may, where appropriate, be applied to any other of these aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a networking system according to an embodiment of the invention.

FIG. 2 is a schematic diagram illustrating a conference environment where the networking system 9 of FIG. 1 can be applied.

FIG. 3 is a schematic diagram illustrating some components of the mobile terminal of FIG. 1;

FIG. 4 is a schematic diagram illustrating the server of FIG. 1;

FIG. 5 is a schematic diagram illustrating the tag board of FIG. 2;

FIG. 6 shows a schematic table illustrating an exemplary storage structure in the storage of FIG. 4;

FIG. 7 is a flow chart illustrating a method performed in the mobile terminal of FIG. 2.

FIG. 8 is a flow chart illustrating a method performed in the server of FIG. 4.

FIGS. 9a-b are schematic screens shown on a display of the mobile terminal of FIG. 1 when the notifying if performed.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

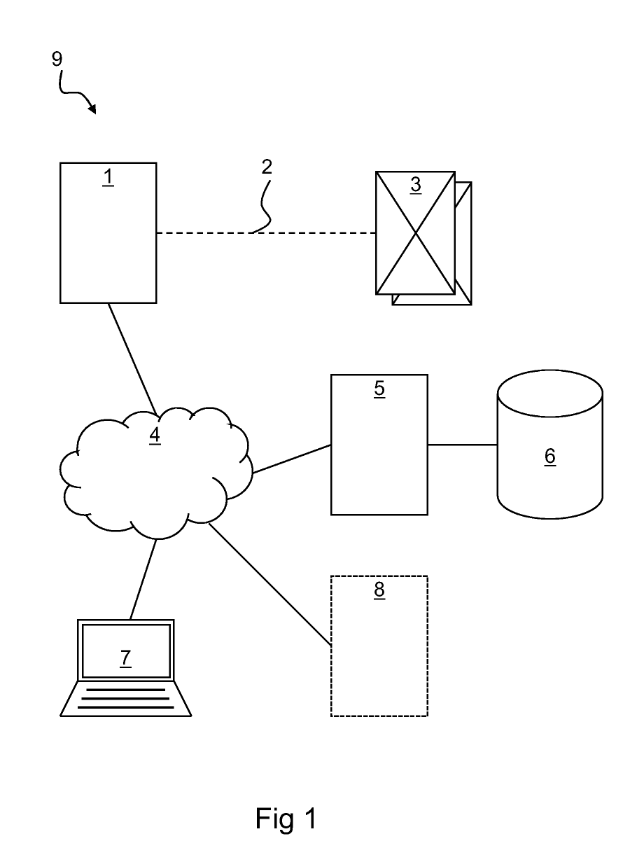

FIG. 1 is a schematic diagram illustrating a networking system 9 according to an embodiment of the invention.

The networking system 9 is used to enable social networking between participants of an event. The event can for example be a professional conference, an academic conference, art exhibition, music festival, etc.

Within the event, participants are given the opportunity to become users of the networking system 9. This allows users to connect with other users of the event. An automatic matching can be done within the networking system 9 based on user profiles. In embodiments of the invention, users of the networking system 9 can efficiently update aspects of their user profile using a mobile terminal 1 and tags 3.

The mobile terminal 1, can be a mobile or cellular phone, a personal digital assistant (PDA), or even a general purpose computer such as a lap top computer. The mobile terminal 1 can be used to indicate a value for a user profile of the event system by obtaining the identity of a tag 3.

The tag 3 can for example be a near field communication (NFC) identifier, e.g. using radio frequency identification (RFID). The communication can optionally comply to the ISO 14443 standard for proximity cards. An advantage with NFC is the ease of use and aesthetics, since the tag can be decorated more or less arbitrarily without interfering with the communication 2. Alternatively, the tag 3 is a bar code, identified by the mobile terminal using optical means, such as a camera or a dedicated barcode reader. An advantage with barcodes is that production costs are low. The bar code can be a traditional one-dimensional bar code with lines, or a matrix code, being a two-dimensional optical machine readable code, such as an Aztec code, MaxiCode, QR (Quick Response) code, Semacode, etc. The tag could also be read using Bluetooth technology, i.e. if the tag data is transmitted with a Bluetooth/IEEE 802.15 sender.

Each tag can be provided with a printed plain text label, indicating to users what the tag in question represents.

There are typically a plurality of tags 3, where the user creates a connection 2 with the tag corresponding to a desired update to the users profile, also known as reading the tag 3.

For example, if the event is a conference for food packaging, there may be a tag for “Packaging supplier” and a tag for “Food producer”. A participant being a supplier of food packaging equipment would then connect his/her mobile terminal 1 to the tag 3 labelled “Packaging supplier” while a participant representing a food producing company would connect his/her mobile terminal to the tag labelled “Food producer”. Furthermore, the participant being the supplier of equipment might also read a tag labelled “Interested in meeting food producers”, indicating that a connection with such other users are desired. As will be seen below, their respective user profiles in the networking system 9 will be updated accordingly and matching will be attempted.

In the communication 2 between the mobile terminal 1 and the tag 3, the identity of the tag 3 is communicated to the mobile terminal 1. Alternatively or additionally, parameters indicating parameter values are communicated to the mobile terminal 1.

The mobile terminal 1 is in connection with a digital network 4 allowing the terminal 1 to communicate with a server 5. The network 4 can for example be a local area network, a wide area network, such as the Internet, or an ad-hoc network such as a Bluetooth ad-hoc network. Optionally, the network is a combination of various networks, e.g. a mobile network and a wide area network; the network only needs to allow communication between the mobile terminal 1 and the server 5.

The server 5 can be any computer suitable for the purposes described herein. For example, the computer 5 can be a general purpose computer running a general purpose operating system such as Linux, Microsoft Windows, Mac OS X or UNIX. The server 5 of FIG. 1 can be located within the premises of an event in question or anywhere else, as long as the server 5 is connectable by the mobile terminal 1.

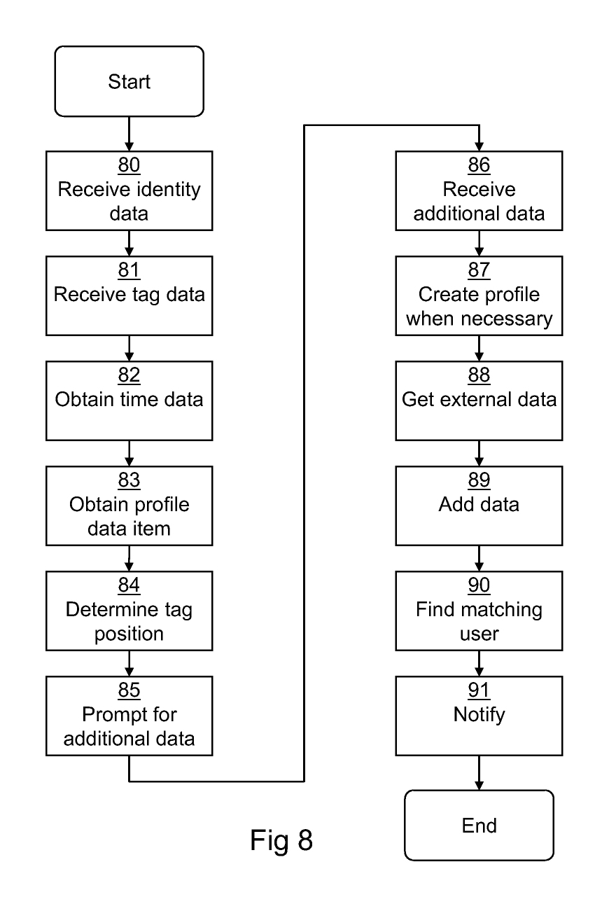

As will be explained in more detail with reference to FIG. 8 below, the server receives the message from the mobile terminal 1 and updates the respective user profile accordingly in a storage 6. The storage can be any suitable storage for user profiles, such as magnetic storage, optical storage, flash memory, random access memory (RAM) or any combination of the above. The storage 6 can be located within the housing of the server 5 or can be located separately, locally or remotely, as is known in the art per se.

Optionally, a client computer 7 is also connected to the network 4, allowing the client computer 7 to communicate with the server 5. Using for example a web client or dedicated software on the client computer 7, a user of the client computer 7 is provided with a rich user interface to the networking system 9. This allows the user to, for example, perform advanced profile management or other networking functions such as posting messages, accessing related third party applications, etc. To support the client computer 7, the server 5 comprises a corresponding module to support the client computer 7, such as a web server or other suitable server software. Optionally, the mobile terminal 1 can also perform the functions of the client computer 7.

Optionally, one or more external systems 8 connected to the network. These can for example be other social networking systems such as Linkedin, Facebook, Plaxo, telephone directories etc, to allow collection of user data from such external systems to facilitate user profile data gathering.

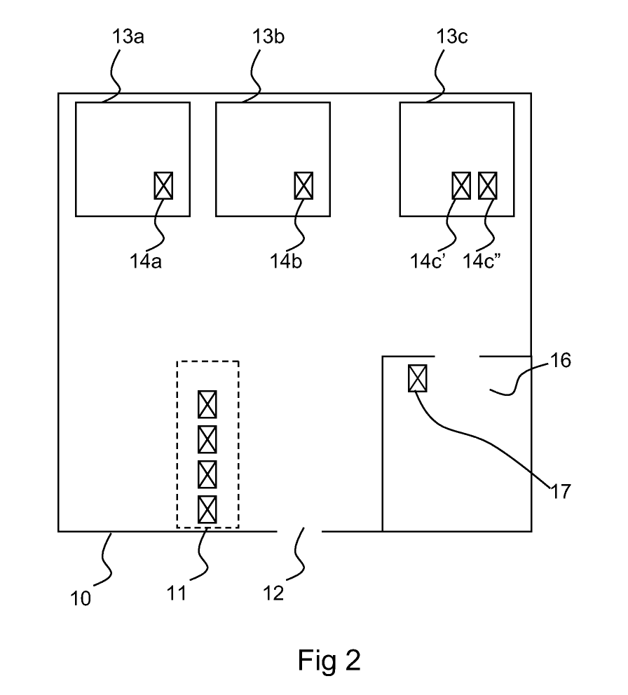

Proceeding to FIG. 2, it is shown a schematic diagram illustrating a conference environment where the networking system 9 of FIG. 1 can be applied.

An event space 10 is a defined space for the event. The event space can be contained in one building or be spread over several buildings in one area or even in various areas inside buildings and/or outdoors, all related to the same event. In the example shown in FIG. 1, the event space 10 is in one continuous area.

By an entrance 12 of the event space 10, it is provided a tag board 11 with a number of tags. Each tag represents a particular way in which a user can update his/her profile. By providing the tag board 11 by the entrance, any new participants can efficiently and intuitively define a user profile by connecting to appropriate tags of the tag board 11.

Within the event space 10, there are three exhibition stalls 13a-c. Any number of exhibition stalls can be provided, as deemed suitable for the event in question, in other words, three exhibition stalls, as provided here, is only an example. Two of the exhibition stalls 13a-b each have a respective tag 14a-b. Any participant can express interest in the exhibitor of the respective stall 13a-b by connecting to the associated tag 14a-b. The exhibition stall 13c has two associated tags 14c′, 14c″. The two (or more) tags can for example represent various products or product lines that any participant can express interest for by reading the respective tag 14c′, 14c″.

Alternatively, the mobile terminal 1 can be used to define specifics by entering additional data. For example, if a user reads tag 14a with a mobile terminal 1, the user may be prompted, in the user interface of the mobile terminal 1, to select which of a number of product lines the user is interested in. Optionally, a hierarchy can be constructed this way allowing a user to navigate to the desired interest to express. Even when multiple tags are used for an area, such as tags 14c′, 14c″ for exhibition stall 13c, the user can optionally be prompted for specifics. It is to be noted that there is a balance between ease of installation and ease of use here. It is possible to imagine a single tag and a complex navigation system to allow the user to express any interest to be added to the user profile, but such a structure is likely to be cumbersome for the user to navigate every time a user profile update is desired. On the other hand, it is quite possible that there are only fixed tags within the event hall 10, allowing the user to define the user profile without providing additional data by means of the user interface of the mobile terminal 1.

Within the event space 10 there is also a lecture hall 16 with an associated tag 17. As long as a time is derivable by the networking system 9 when the tag is read by a mobile terminal 1, it is possible to associate a user of a mobile terminal 1 reading the tag 17 with the correct lecture of the lecture hall 16, using a schedule of lectures.

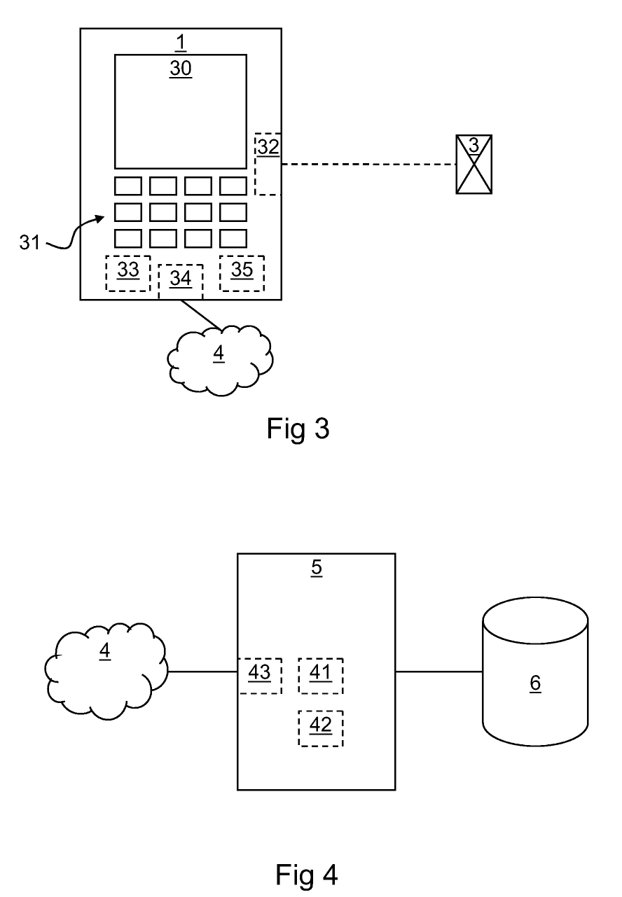

FIG. 3 is a schematic diagram illustrating some components of the mobile terminal of FIG. 1. The mobile terminal 1 comprises a display 30 and input means 31, collectively forming part of the user interface of the mobile terminal 1. The input means 31 can for example be a keypad, a regular keyboard, voice control via a microphone, etc. The display 30 and the input means 31 can optionally be combined, e.g. in a touch sensitive display. A tag reader 32 is provided, e.g. a near field communication reader, a camera or dedicated reader for reading bar codes or matrix codes, a Bluetooth transceiver, etc, or any combination of tag readers. Furthermore, as is known in the art per se, the mobile terminal 1 comprises a controller 33 and a first computer program product 35 in the form of a first internal memory. The first internal memory is adapted to store software instructions that can be executed by the controller 33. The first internal memory can be any suitable memory e.g. comprising at least one of magnetic storage, optical storage, flash memory, read only memory (ROM), random access memory (RAM) and EEPROM (Electrically Erasable Programmable ROM).

A network interface 34, known per se, is provided to allow the mobile terminal to connect to the network 4, acting both as a receiver and a transmitter. The network interface 34 can for example be compliant with any IEEE 802.11 standard, WiMAX, any suitable mobile network standard such as Global System for Mobile communications (GSM), third generation mobile networks (3G) such as Universal Mobile Telecommunications System (UMTS), Freedom of Mobile Multimedia Access (FOMA), code division multiple access 2000 (CDMA2000) or fourth generation (4G) mobile networks such as Long Term Evolution (LTE). The network also allows two or more users of the networking system to contact each other using for example, instant messaging, e-mail, short message service (SMS), multimedia messaging service (MMS), voice call, video call or any other digital communication technology.

FIG. 4 is a schematic diagram illustrating the server 5 of FIG. 1. The server 5 comprises a network interface 43 which is known per se and allows the server 5 to communicate using the network 4. Furthermore, the server 5 comprises a controller 41, such as a central processing unit (CPU) and a second computer program product 42 in the form of a second internal memory. The second internal memory can hold software instructions which are to be executed by the controller 41. The second internal memory can be any suitable memory e.g. comprising at least one of magnetic storage, optical storage, flash memory, read only memory (ROM), and random access memory (RAM). The server 5 is also connected to the storage 6 which stores user profiles of the networking system 9. Optionally, the server is provided with a user interface (not shown).

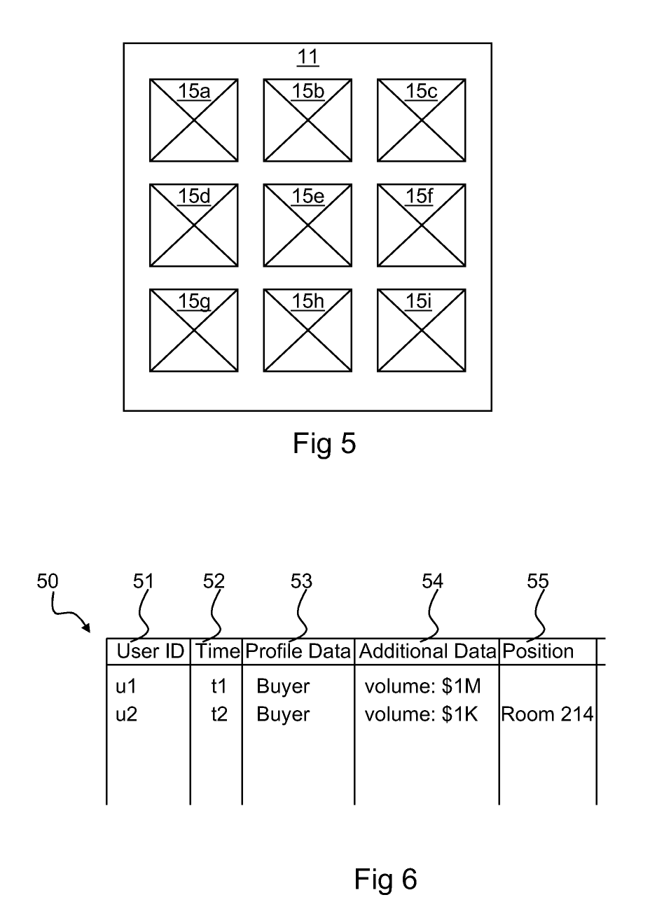

FIG. 5 is a schematic diagram illustrating the tag board 11 of FIG. 2. The tag board comprises a number of tags 15a-i, in this example nine tags. The tags are sufficiently separated from each other to allow unambiguous reading by a user of a desired tag 15a-i. The required physical separation distance depends on what tag technology is used. By providing a number of tags in proximity, it allows a user to efficiently create a user profile. For example, the tag board 11 can be provided with tags allowing a user to define aspects of the user profile such as a professional role, an employer, an age, a country of residence, employer size, subject area of interest, seniority, intended purchase volume, desired profiles to connect with, etc. by simply reading appropriate tags 15a-i. The tags can be physically arranged to simplify the selection process, e.g. by grouping different alternatives to one variable together.

FIG. 6 shows a schematic table illustrating an exemplary storage structure in the storage of FIG. 4. A data table 50 comprises a number of columns 51-55 indicating various aspect of a user. In this example, there is a column 51 indicating user ID, a column 52 indicating a time that of a tag reading, a column 53 indicating the profile data, a column 54 indicating additional data and a column 55 indicating a position. While it is here shown two records 58 of the data table 50, there are typically many more records of the table 50 when the networking system is active. Furthermore, there may be more columns in the data table 50 not shown here.

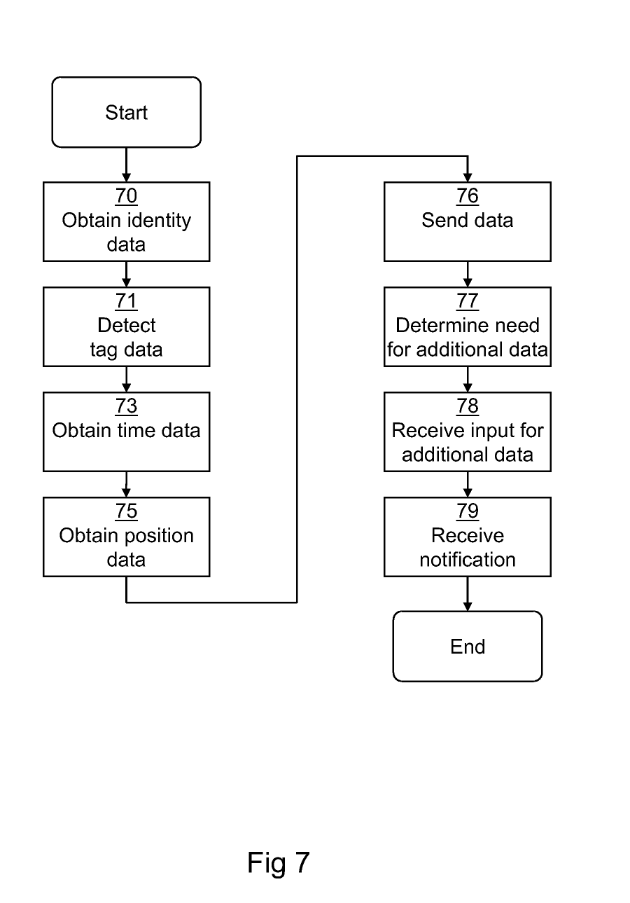

FIG. 7 is a flow chart illustrating a method performed in the mobile terminal 1 of FIG. 2. The method is performed when the user of the mobile terminal reads a tag 3.

In an initial obtain identity data step 70, an identity of the user is obtained. This identity can for example be a phone number, e.g. an MSISDN number, associated with the mobile terminal 1 (e.g. using a subscriber identity module, SIM). Optionally, it can be a user identity selected by the user which has been input to the mobile terminal 1 and stored within the internal memory 35 (FIG. 3) of the mobile terminal 1.

In a detect tag data step 71, tag data is detected. The tag data is data of the tag 3, such as the identity of the tag 3.

Optionally, the mobile terminal obtains a current time in step 73. This step is optional, since the time could also be obtained at a later stage on the server side. It is more accurate to obtain the time in the mobile terminal 1, but for the purpose of social networking, the delay of processing and communication is typically negligible and the time could be obtained only on the server side.

In another optional step 75, position data is obtained using any suitable position determination technology. This can for example be triangulation of base stations in a mobile network, or global positioning system (GPS) where applicable. As will be explained in more detail below, position data can also be obtained on the server side by the tag being associated with a location.

When the relevant information has been obtained in the mobile terminal 1, it is sent to the server 5 over the network 4 in the send data step 76. For example, a message containing all the data can be sent over the network 4 using TCP/IP.

In an optional step 77 to determine need for additional data, the mobile terminal determines that additional data is associated with the detected tag. This can be example be by receiving a message from the server indicating the need to prompt for additional data. The text labels for prompting the user for additional data as well as possible choices or type of input, e.g. multiple exclusive selection, multiple selection, number input, text input, etc., can thus be obtained from the server. For example, a tag indicating “Purchasing volume” can be associated with the text label “Please indicate annual purchasing volume in dollars” and the additional data being a number input. Optionally, all or some of the tags associated with additional data is stored in the local memory in the mobile terminal along with any text labels and input type, thereby reducing or eliminating the need for additional messages to be sent from the server.

In the receive input for additional data step 78, the user is prompted, using the user interface of the mobile terminal 1, to provide additional data. This data is then sent to the server. Optionally, this additional data is sent with the other data in the send data step 76.

The server 5 externally processes the data (steps 80-90 of FIG. 8) and if there is a match found with another user in the networking system 9, a notification of the match is received in the receive notification step 79. The user can then initiate contact with the other user if desired. The contact details are then also received in the receive notification step 79, allowing the mobile terminal to connect to the matching user.

The method of FIG. 7 can be executed by means of a computer program stored in the first computer program product 35 executed in the controller 33 (FIG. 3) of the mobile terminal 1. For example the computer program can be a Java program or a Symbian program.

FIG. 8 is a flow chart illustrating a method performed in the server 5 of FIG. 4. This method is arranged to correspond to the method described with reference to FIG. 7. The method starts when the server 5 detects communication from the mobile terminal 1.

In an initial receive identity data step 80, the user identity associated with the sending mobile terminal 1 is determined from the communication from the mobile terminal.

Tag data is then received from the mobile terminal 1 in a receive tag data step 81. The tag data can be the tag identity.

In the step 82 called obtain time data, the time is obtained. This can either be obtained in the communication from the mobile terminal or it can be determined in the server 5 as a current time.

When the tag data has been obtained, i.e. the tag identity, a profile data item is obtained in step 83, e.g. by mapping between tag identities and profile data item. Each tag identity can be mapped to a profile variable and value. as can be seen in Table 1 below:

TABLE 1
Sample mapping between tag data and profile data

| | Profile | Profile | |
|---|---|---|---|
| Tag data | variable | value | Position |
| 1000 | Professional | buyer | Main |
| | role | | entrance |
| 1001 | Professional | seller | Main |
| | role | | entrance |
| 1002 | Employer | Acme Inc. | Main |
| | | | entrance |
| 1003 | Age | 30-44 | Main |
| | | | entrance |
| 1004 | Country of | U.S.A. | Main |
| | residence | | entrance |
| 1005 | Employer | 1000-5000 | Main |
| | size | | entrance |
| | (revenue | | |
| | MUSD/year) | | |
| 1006 | subject area | Paper based | Main |
| | of interest | packaging | entrance |
| 1007 | Seniority | Vice | Main |
| | | president | entrance |
| 1008 | Intended | 1-5 | Main |
| | purchase | | entrance |
| | volume | | |
| | (MUSD) | | |
| 1009 | Company of | Foo | Exhibition |
| | interest | | hall I, |
| | | | stand A6 |
| 1010 | Company of | Bar | Exhibition |
| | interest | | hall II, |
| | | | stand C2 |

Table 1 represents just a sample and there are typically many more records in the table for each profile variable.

Optionally, in a determine tag position step 84, a position of the tag is determined. For example, the position can be obtained from table 1. The position can be a pair of coordinates, such as longitude and latitude, or it can be plain text, such as “Exhibition hall I, stand A6” or “Room 214”. The level of detail of the location data can be chosen to an appropriate level of privacy, balanced against granularity of information. If the location information is plain text, this can conveniently be added to profile information such as “Last seen in Room 148”, facilitating participants to locate each other.

Optionally, if it is determined that the tag has additional data associated with it (e.g. using an additional column in Table 1), in the step 85 prompt for additional data, the server 5 sends a message to the mobile terminal to prompt for additional data. The message typically includes a text label and data regarding what input type is desired. Optionally, the determination and form of additional data is performed in the mobile terminal, reducing or eliminating the need for this step.

In an optional step 86 called receive additional data, any additional data as input by the user to the mobile terminal 1 is received in the communication from the mobile terminal 1.

Optionally, if there is no prior user profile stored for the user in question, a new profile is created in a create profile when necessary step 87. This significantly improves usability of the networking system 9, enabling a new user to simply read tags reflecting the user.

In an optional step 88 to get external data, external data is obtained from an external system 8 (FIG. 1). For example in the case of conferences, there may be information such as name, address and company submitted at the time of registration. This information can be retrieved to even more facilitate the population of data in the profile. For example, when the user ID is the phone number (e.g. MSISDN number), this can be used as a key to retrieve data from the registration form. In this way, a new user does not need to enter data such as name, company, etc. In another example, the user can submit a user ID and password to an external system, e.g. an external networking system such as LinkedIn, Facebook, Plaxo, telephone directories, etc. This allows the networking system 9 to obtain profile data from the external system 8. Optionally, the user can indicate what subset of data to obtain from the external system by reading an appropriate tag associated with the desired subset of information, e.g. a tag for “get name and contact details from Facebook” or “get name, contact details and professional history from LinkedIn”.

Once all data has been retrieved, the data is added in an add data step 89. It is to be noted that the data can equally well be fetched and added in increments; it is not necessary to fetch all data first and then add all data at once to the user profile.

Once the data has been added, the networking system 9 attempts to find a matching second user in the find matching user step 90. The first user here refers to the user that has just added to his/her user profile. In one example, the first user has just added data that he/she is a purchaser of packaging machines at a conference. If there is a second user with profile data indicating the desire to meet participants being buyers of packaging machines, there is a match between the two. It is to be noted that the new data can result in any number of matches, e.g. 0, 1, 2, 3, etc matches. By finding matching users each time there is an addition of user profile data, polling is avoided. On the other hand, it is also possible to use polling, whereby the find matching user step 89 is performed periodically, for all or a subset of users.

The matching algorithm can be triggered by reading a tag, on behalf of either the first user or the second user. The match is based on the criteria in variables stored in the personal profiles of the first user and the second user. Two steps have to be taken each time a tag is read. Firstly, look through the first user's criteria and find a potential match (the first user is the requester). Secondly, check all profiles (or a specially stored matching directory) to see if this action by the first user should trigger matching. If so, base match on the second user's criteria (the second user is the requester). The matching is performed based on the matching criteria stored in the personal profile of the requester.

Further examples of criteria are: expressed the same or complementary interest in the same aspect, same or complementary interest in a plurality of aspects, location or attended the same lectures or visited the same booths. Matching can also be asked for manually.

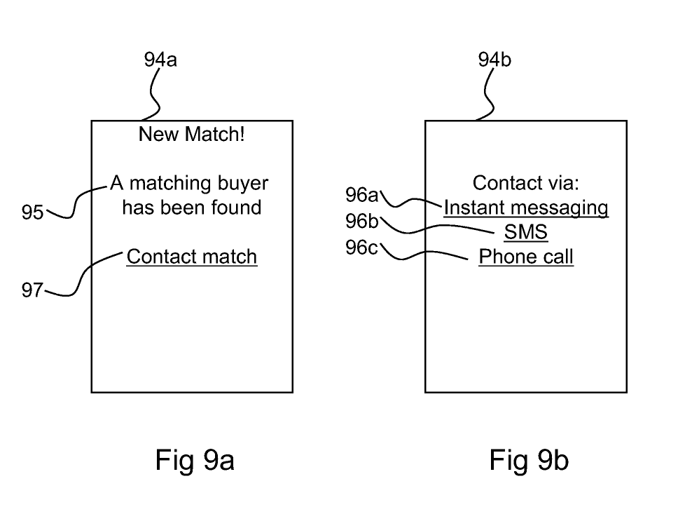

In a notify step 91, at least one of the matched parties is notified. In other words, either one or both parties of each match can be notified of the new match. This is effected by the server sending a message to the mobile terminal. The mobile terminal can thus present a text and/or image on the screen. Alternatively or additionally, a sound is generated and/or vibration to get the attention of the user. The user can optionally be presented with one or more ways to contact the other user, as will be explained in more detail below with reference to FIG. 9a-b.

Due to the simplicity of creating user profiles, in one embodiment, all user profiles are removed from the storage after the event is finished. In other words, the user profiles are only active during the conference, trade fair, art exhibition, music festival, etc. This simplifies the administration of the networking system 9 considerably.

The method of FIG. 8 can be executed by means of a computer program executed in the controller 41 (FIG. 4) of the server 5.

FIGS. 9a-b are schematic screens shown on the display 30 of the mobile terminal 1 when the notifying is performed.

FIG. 9a shows a screen 94a which is initially displayed when a new match is found. A text 95 is displayed indicating the match and the user is provided with a way to contact the other user, such as a link 97. Alternatively, soft buttons can be used, whereby a label would have been presented e.g. at the bottom of the screen adjacent to a soft button in question.

FIG. 9b shows a screen 94b with various ways to contact the user. Here the examples shown are instant messaging 96a, SMS 96b and phone call 96c.

Finally, an example illustrating the use of an embodiment will now be presented. This is one example, which serves to illustrate the concept.

A large trade organization arranges a trade fair, with exhibitions and guest speakers. A professional event organizer handles all practical arrangements, including operating the networking system. The fair is defined in the system as a separate event, meaning it is separate from user databases of any other events. The trade organization decides on system parameters like: pre-defined responses for tags, default matching criteria, and default privacy policy.

Users can pre-register to the event, but also just go spontaneously. At the entrance there are NFC tags containing fair information. Touching the phone to this tag is regarded as reading a tag by the system, and sets up a user profile.

All exhibition stands at the fair have NFC tags which users can touch with their phones to read and leave comments. Bluetooth positioning infrastructure is in place and enables proximity search and location information. Positioning inside a lecture room automatically updates user profile with interest in the current lecture.

The invention has mainly been described above with reference to a few embodiments. However, as is readily appreciated by a person skilled in the art, other embodiments than the ones disclosed above are equally possible within the scope of the invention, as defined by the appended patent claims.

1-16. (canceled)

17. A method performed in a server, said method comprising:
receiving from a mobile terminal identity data that identifies a first user;
receiving from said mobile terminal tag data that is associated with a tag and that has been detected by the mobile terminal using local communication;
obtaining time data related to when said tag data was detected;
determining a tag position that indicates a position of said tag, by reading a position associated with the tag data;
creating a user profile for said first user in a database containing user profiles, if said database does not already include a user profile for said first user;
adding to said user profile for said first user the time data, the tag position, and a profile data item that is mapped to said tag data, wherein said user profile is identified using said identity data; and
finding in said database a user profile of a second user that matches said user profile of said first user according to at least one criteria.

18. The method according to claim 17, comprising conditioning said finding on privacy policies of both said first and second users being complied with.

19. The method according to claim 17, further comprising receiving additional data that corresponds to user input received from said first user and that is coupled to said tag data.

20. The method according to claim 17, wherein said profile data item represents a professional interest of said first user, said professional interest comprising at least one of a professional role, an employer, an age, a country of residence, an employer size, a subject area of interest, seniority, and an intended purchase volume.

21. The method according to claim 17, wherein said user profile for said first user is associated with an event, and wherein the method further comprises removing said user profile from the database after the event has ended.

22. The method according to claim 17, further comprising notifying at least one of said first user and said second user of a match between said first user and said second user.

23. A method performed in a mobile terminal, comprising:
obtaining identity data that identifies a first user;
detecting tag data associated with a tag using local communication of said mobile terminal;
sending said identity data and said tag data to an apparatus for adding a profile data item mapped to said tag data to a user profile for said first user, said profile data item comprising a tag position determined by reading a position associated with the tag data; and
responsive to sending said tag data, receiving notification that a user profile has been created for the first user.

24. The method according to claim 23, further comprising receiving user input for additional data coupled with said tag data.

25. The method according to claim 23, wherein said local communication comprises at least one of near field communication, one dimensional barcode reading, two dimensional barcode reading, and Bluetooth.

26. The method according to claim 23, wherein said sending comprises sending said identity data and said tag data using a data transfer technology that comprises at least one of a local area network, wide area network, and a Bluetooth network.

27. The method according to claim 23, wherein obtaining identity data comprises obtaining an identifier of a subscriber associated with said mobile terminal.

28. The method according to claim 23, further comprising receiving notification that a match has been found between the user profile of the first user and a user profile of a second user, according to at least one criteria.

29. The method according to claim 23, wherein said profile data item represents a professional interest of said first user, said professional interest comprising at least one of a professional role, an employer, an age, a country of residence, an employer size, a subject area of interest, seniority, and an intended purchase volume.

30. A server comprising a controller configured to:
receive from a mobile terminal identity data that identifies a first user;
receive from said mobile terminal tag data that is associated with a tag and that has been detected by the mobile terminal using local communication;
obtain time data related to when said tag data was detected;
determine a tag position that indicates a position of said tag, by reading a position associated with the tag data;
create a user profile for said first user in a database containing user profiles, if said database does not already include a user profile for said first user;
add to said user profile for said first user the time data, the tag position, and a profile data item that is mapped to said tag data, wherein said user profile is identified using said identity data; and
find in said database a user profile of a second user that matches said user profile of said first user according to at least one criteria.

31. A mobile terminal comprising:
a detector configured to use local communication to detect tag data associated with a tag;
a controller configured to obtain identity data that identifies a first user and to obtain time data for when said tag data was detected;
a transmitter configured to send said identity data and said tag data to an apparatus for adding a profile data item mapped to said tag data to a user profile for said first user, said profile data item comprising a tag position determined by reading a position associated with the tag data;
a receiver configured to receive, responsive to sending said identity data and said tag data, notification that a user profile has been created for the first user, and to receive notification indicating that a match has been found between said user profile of said first user and a user profile for a second user according to at least one criteria.

32. The mobile terminal according to claim 31, wherein said detector is configured to use at least one of near field communication, one dimensional barcode, two dimensional barcode, and Bluetooth as said local communication.

33. A computer program product stored on a computer readable medium and comprising software instructions that, when executed in a server, cause the server to manage user profiles in a database, said server configured to receive from a mobile terminal identity data that identifies a first user and tag data that is associated with a tag, said tag data having been detected by the mobile terminal using local communication, and wherein said software instructions cause the server to:
obtain time data related to when said tag data was detected;
determine a tag position that indicates a position of said tag, by reading a position associated with the tag data;
create a user profile for said first user in the database, if said database does not already include a user profile for said first user;
add to said user profile for said first user the time data, the tag position, and a profile data item that is mapped to said tag data, wherein said user profile is identified using said identity data; and
find in said database a user profile of a second user that matches said user profile of said first user according to at least one criteria.

34. A computer program product comprising software instructions that, when executed in a controller of a mobile terminal, causes the mobile terminal to:
obtain identity data that identifies a first user;
detect tag data associated with a tag using local communication of said mobile terminal; and
send said identity data and said tag data to an apparatus for adding a profile data item mapped to said tag data to a user profile for said first user, said profile data item comprising a tag position determined by reading a position associated with the tag data;
wherein the mobile terminal is configured, responsive to sending said tag data, to receive notification that a user profile has been created for the first user.
